(19) United States
(12) Patent Application Publication
(10) Pub. No.: US 2010/0262963 A1
(43) Pub. Date: Oct. 14, 2010

(54) SYSTEMS AND METHODS FOR ACTIVATING A NETWORK APPLIANCE

(76) Inventors: Gary Michael Wassermann, Davis, CA (US); Abdullah Metin Sagal, Roseville, CA (US); David Mark Nelson, Chico, CA (US); Dante Vitale, Colfax, CA (US)

Correspondence Address: INTERTRUST TECHNOLOGIES CORP., 460 OAKMEAD PARKWAY, SUNNYVALE, CA, 94086, US

(21) Appl. No.: 12/421,152

(22) Filed: Apr. 9, 2009

(51) Int. Cl. G06F 21/00; G06F 9/445

(52) U.S. Cl. 717/178; 726/27; 717/176

(57) ABSTRACT

A method of activating a network appliance that can include obtaining a computer hardware module having installed an open architecture operating system and licensing architecture software with a hardware module identification, receiving a user registration identification that is preconfigured in accordance with a user's selection compute resource application(s) for a selected duration of time, and submitting the hardware module identification and user registration identification to an internet-based license database server for providing an activation license or install key. Additional steps include accepting an install key from the license database server comprising a module identification code and software product selector code, entering the install key into the licensing architecture software on the hardware module, using the module identification code to enable the hardware module, and using the software product selector code to enable the one or more compute resource application for the selected duration of time.

### BACKGROUND

A computer or network appliance is a discrete hardware component specifically designed to provide a particular networking compute resource, such as a firewall resource, a load-balancing resource, a diagnostic tool resource, a storage computing resource, etc. In the modern data center environment comprised of networks of blade servers, the network appliance can comprise a specialized blade that plugs into a network switch chassis along with other network appliances and blade servers.

### BRIEF DESCRIPTION OF THE DRAWINGS

Features and advantages of the present disclosure will be apparent from the detailed description that follows, and when taken in conjunction with the accompanying drawings together illustrate, by way of example, features of the disclosure. It will be readily appreciated that these drawings merely depict representative embodiments of the present disclosure and are not to be considered limiting of its scope, and that the components of the disclosure, as generally described and illustrated in the figures herein, could be arranged and designed in a wide variety of different configurations. Nonetheless, the present disclosure will be described and explained with additional specificity and detail through the use of the accompanying drawings, in which:

FIG. 1 is a flowchart depicting a method for activating a network appliance, in accordance with one representative embodiment of the present disclosure;

FIG. 2 is a schematic view of a computer or network system for activating a network appliance, in accordance with the embodiment FIG. 1; and

FIG. 3 is a schematic view of a computer or network system for removing or transferring activation codes from one user to another, in accordance with another representative embodiment of the present disclosure.

### DETAILED DESCRIPTION

The following detailed description of representative embodiments of the present disclosure makes reference to the accompanying drawings, which form a part hereof and in which are shown, by way of illustration, various representative embodiments in which the teachings of the disclosure can be practiced. While these embodiments are described in sufficient detail to enable those skilled in the art to practice the disclosure, it should be understood that other embodiments can be realized and that various changes can be made to the disclosure without departing from the spirit and scope of the present invention. As such, the following detailed description is not intended to limit the scope of the disclosure as it is claimed, but rather is presented for purposes of illustration, to describe the features and characteristics of the present disclosure, and to sufficiently enable one skilled in the art to practice the disclosure. Accordingly, the scope of the present invention is to be defined by the appended claims.

As stated previously, a computer or network appliance is a discrete hardware component specifically designed to provide a particular networking compute resource. A representative sampling of network appliances can include, but is not limited to, a load balancing appliance, a firewall appliance, a voice-over-IP telephone switch appliance, a wireless network appliance, a data processing appliance, a data storage computing appliance, an optical communications interconnect appliance, and a diagnostic tool appliance, etc. In today's data center environment, networks can be comprised of multiple blade servers grouped together in racks and towers and connected together over a common high-speed internal backplane. In such environments, the network appliance can comprise a specialized blade that plugs into a network switch chassis along with other network appliances and blade servers.

In many cases, the network appliance is a compute resource software application running on a closed operating system loaded onto a dedicated and specialized hardware platform that has been optimized for the specific compute resource. Such network appliances can be shipped as a hardware module with the compute resource application pre-installed, with the intent that only that software run on that module hardware. For business reasons, the hardware module is often sealed so that the end-user has no access to reinstall or replace the operating system or to update the compute resource, thus forcing the end-user into contracting additional services and support to maintain the network appliance. In such closed configurations, licensing for the both the hardware module and the software application is not an issue since the hardware and software are bundled and maintained together.

In other cases, however, the network appliance can be comprised of a compute resource software application running on an open architecture (“OA”) operating system loaded onto a general purpose hardware platform. This allows the hardware module to ship separately and provides a third-party vendor (such as a reseller) or an end-user with an opportunity to configure, construct, or repurpose the network appliance by loading one or more compute resource applications onto the hardware module. In contrast with dedicated network appliances, OA network appliances allow the customer to update, uninstall or overwrite the compute resource applications loaded onto any particular module, move the compute resource applications between hardware modules, or even add third-party applications to the original network appliance. Thus, while the open systems architecture provides the end-user with more flexibility in provisioning, operating and maintaining his network of blade servers, the vendors of both the general purpose hardware platforms and the proprietary compute resources applications must often resort to cumbersome licensing installations to ensure their continued revenue streams and minimize the risk of unauthorized users and rogue combinations of compute resource applications and hardware modules.

The present disclosure describes a method and system for activating a network appliance. More specifically, and in accordance with a representative embodiment, the present disclosure can include a licensing scheme for managing licenses for both the hardware module and the one or more compute resources loaded onto the hardware module, to enable activation of the network appliance. The hardware module can be a general purpose hardware module or blade server, and the installed compute resource(s) can run on or alongside an OA operating system installed or imaged onto the general purpose hardware module. Additionally, the licensing scheme can be controlled by software that is also loaded onto the OA operating system along with the one or more compute resources

In a representative embodiment, the network appliance can comprise a Hewlett-Packard (“HP”) Services Module imaged with the HP Open Network Ecosystem™ operating system, and can further include an HP licensing architecture software along with the MyProCurve™ website for applying the licensing scheme. Other similar systems outside of this HP specific system can also be used.

The method and system of the present disclosure can include the capability to manage the licenses of a lone compute resource installed onto a single hardware module, in a configuration consistent with that used by many end-users. The licensing scheme can also provide the capability to manage the licenses of multiple compute resource applications installed onto a single hardware module, in a configuration consistent with that used by third-party venders and resellers to engage in sales demonstrations and timed trial periods. The licensing scheme can further include the capability to transfer the licenses for the one or more compute resources and the hardware module from one licensee to another licensee, such as from a reseller to an end-user, with uninterrupted operation of the network appliance. When a license is transferred, the licensing scheme is also capable of changing the operating mode of the license, for example from a timed trial period or limited capacity license to an indefinite or full-use license, with uninterrupted operation of the network appliance.

The method and system can also include the capability to activate the licenses of the one or more compute resources installed onto a particular hardware module for a pre-selected period of time, both individually and/or for multiple applications, for up to and including an unlimited duration. Furthermore, the licensing scheme can include the capability of disabling the one or more of the compute resources installed onto a particular hardware module when the pre-selected period of time expires, to deactivate the network appliance and enforce end-of-license compliance.

In a representative embodiment, the method and system of the present disclosure can include a single, unique “install key” that is associated with a particular hardware module, and which can enable the one or more compute resources installed on that hardware module in order to activate the network appliance. The install key can be associated with the hardware module, the one or more compute resources installed on that hardware module, and the customer who has paid the fees or entered into a contract authorizing the use of that module as a network appliance. The install key can be provided by an internet-based license database that is accessible from any remote location having access to the internet, and which can operate with the licensing architecture software that has been loaded along with the one or more compute resources into the hardware module.

In the situation where a network appliance is passed between licensees, the method and system of the present disclosure can allow the install key to be removed from the particular hardware module by the licensing architecture software and returned to the license database, which can then generate a replacement install key to allow the licensee to enable the compute resource on a different hardware module. Furthermore, a new install key associated with the original hardware module and compute resources and the new licensee can be provided by the license database to activate the network appliance for the new licensee. In this way the network appliance can be flexibly utilized, transferred and re-deployed between end-users and resellers as the need arises or conditions change, while allowing the vendors of both the hardware modules and the proprietary compute resources to ensure their continued revenue streams and monitor the use of their products in industry.

The present disclosure can provide several significant advantages over prior-related licensing schemes, some of which are recited here and throughout the following detailed description. For instance, the method and system can provide a unique flexibility that allows a single licensing scheme to be shared amongst resellers and end-users. In prior-art licensing systems, for example, a reseller may be provided with a master key (whether a hardware-based “dongle” key or an encrypted software key) that enables multiple applications to be run on a single hardware module for demonstration purposes. Meanwhile, the end-user may be provided with a single software license for each compute resource that must be individually installed. This segregated licensing method can make it difficult and cumbersome to transfer a module from a reseller to the end-user after the demonstration is complete, or for the end-user to conduct an extended, on-site evaluation of various products before making a commitment to a particular network appliance. The segregated licensing method can also make it a burdensome and complex task for the hardware and software providers to keep track of which compute resource applications have been combined with what hardware modules for operation in which types of network environments, which information can be very valuable in isolating problems, debugging errors and planning updates and improvements. Furthermore, the master key approach creates additional security issues by increases the risk of unauthorized users gaining access to the hardware modules and compute resources and operating one or more network appliances without payment.

In contrast, the licensing scheme of the present disclosure provides similar install keys to both resellers and end-users, with any install key able to be configured at the time of its creation for single or multiple-compute resource applications and for any specified duration of time. This integrated approach, in combination with the centralized internet-based license database, provides increased flexibility and usability of the OA platform. The licensing scheme can enable an end-user to try various applications on one blade before deciding which to buy, thereby increasing the value of the OA blade in the eyes of the customer, while also allowing a reseller or sales representative to demonstrate multiple applications to other vendors and end-users without having to rely on a master key or go through licensing installation at each change of application. This can result in a more efficient demonstration process for the reseller. Furthermore, the method and system of the present disclosure can eliminate the master key approach and its attendant security risks, while allowing for the seamless passing of the licenses associated with a particular network appliance from one customer to another.

Each of the above-recited advantages will be apparent in light of the further detailed description set forth below and best understood with reference to the accompanying drawings, wherein the elements and features of the disclosure are designated by numerals throughout. These advantages are not meant to be limiting in any way. Indeed, one skilled in the art will appreciate that other advantages can be realized, other than those specifically recited herein, upon practicing the present disclosure.

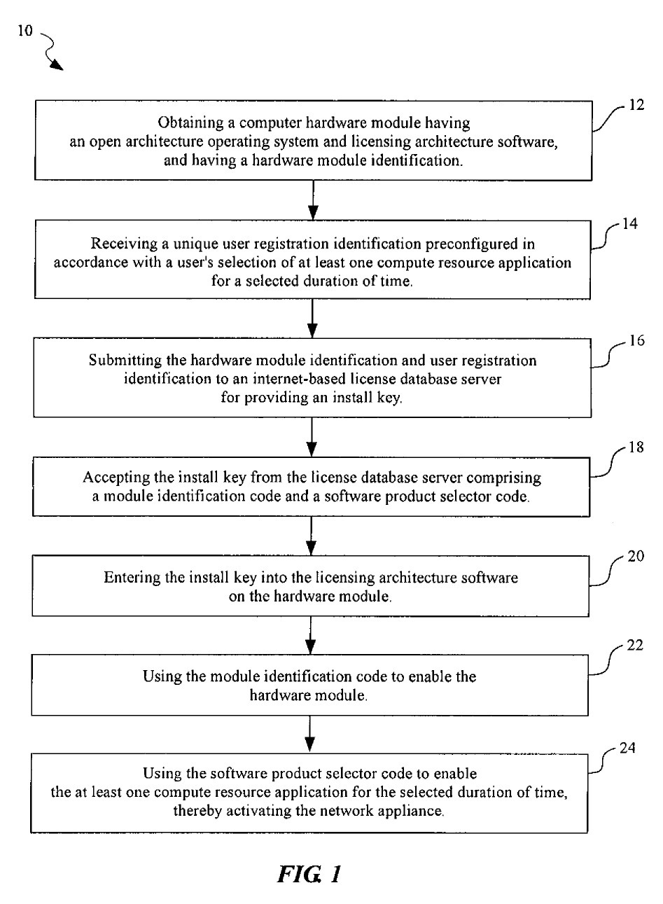

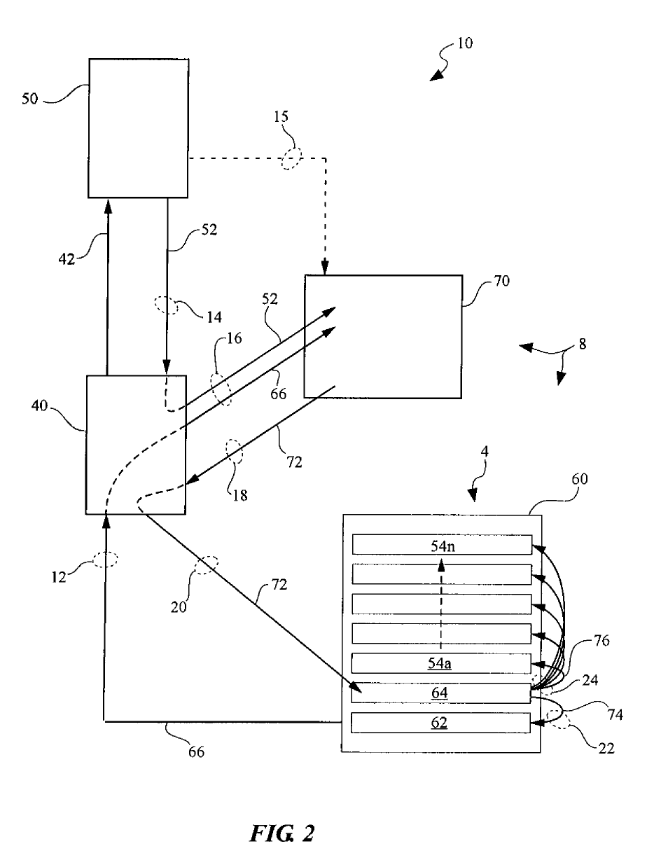

Illustrated in FIG. 1 is a flowchart depicting a method 10 for activating a network appliance in accordance with one representative embodiment of the present disclosure. Additionally, a schematic view of a representative computer or network system 8 which includes the network appliance 4 being activated in accordance with method 10, is provided in FIG. 2.

As shown generally in FIG. 1 and with more detail in FIG. 2, the method 10 includes the step of obtaining 12 a computer hardware module 60 having an open architecture (“OA”) operating system 62 and a licensing architecture software 64, and having a unique hardware module identification or Module ID 66. The Module ID can be provided by the supplier of the hardware module, and can include all or part of the hardware module's serial identification number. The Module ID can be a unique ID number like a serial number of a MAC address or a cryptographically secure, tamper-proof identifier, etc.

In one aspect, the OA operating system 62 supplied with the hardware module 60 can be a generalized operating system such as Windows or Linux, etc. In another aspect of the present disclosure, however, the OA operation system can be separated into a service operating system performing the basic functions of the module, and an application-specific operating system included with the separately installed compute resource software applications 54a . . . 54n (discussed in more detail below), that both installs and boots up with the compute resource software applications to run the applications on the hardware module. The variable “n” can represent as many software applications as are desired for installation, from one to a few to many programs, and should not be limited in accordance with embodiments of the present disclosure. In such configurations, the licensing architecture software 64 can be included with the service operating system and/or the application-specific operating system.

In one representative embodiment, the hardware module can be an HP (Hewlett-Packard) blade server or services module running the HP Open Network Ecosystem™ operating system and an HP licensing architecture software. It is to be appreciated by one of ordinary skill in the art, however, that the licensing scheme of the present disclosure can also be applied to non-HP server blades running non-HP operating systems and licensing architectures.

The obtained hardware module 60 of method 10 can be supplied to the user 40 with the OA operating system 62 and licensing architecture software 64 installed or imaged onto the hardware module, but without any compute resource software applications 54a . . . 54n being installed. Thus, one or more compute resource software applications can be loaded onto the hardware module by a third-party vendor (such as a reseller) or by an end-user. In one embodiment, multiple applications 54a . . . 54n can be loaded together as a software application bundle, with each application in the bundle being pre-configured to run on the OS operating system and having its own specific compute resource application identification or Application ID. The Application ID can be recognizable or useable by the licensing architecture software in implementing the method and system of the present disclosure. The Application ID can be tamper resistant in order to reduce the risk of software theft.

In another representative embodiment, the obtained hardware module 60 can be supplied with the customer with the OA operating system 62, licensing architecture software 64 and application bundle 54a . . . 54n pre-installed or imaged onto the hardware module.

It is to be appreciated that the compute resource software application or application bundle 54a . . . 54n can be initially disabled after being loaded onto the hardware module 60, and that the one or more applications may not operate without first being activated by the licensing architecture software 64. And as will be discussed in more detail below, the licensing architecture software can be unable to activate the application(s) without first receiving the correct install key 72 that is associated with the specific module 60 and the installed compute resource software application or application bundle 54a . . . 54n.

The method 10 of the present disclosure further includes the step of receiving 14 a unique user registration identification or Registration ID 52 that is associated with a user's 40 selection of the one or more compute resource applications, and for one or more tamper-proof, pre-configured durations of time. The Registration ID can be supplied by the vendor 50 of the compute resource software application or application bundle in return for payment of a fee 42 or entering into a contract, etc. The Registration ID can specify the duration of time, such as a number of remaining days, during which one or more of the approved applications 54a . . . 54n will remain active. The specified time period for activation can also be for an unlimited duration of time. If multiple software applications have been installed onto a single hardware module, the applications can be treated individually (so that different applications can be activated for different durations of time) or as a group (so that all applications installed on the module can be activated for the same duration of time).

Thus, even though a network appliance 4 with an OA operating system 62 can allow the user 40 to load any compute resource software application or application bundle 54a . . . 54n onto the hardware module 60, with the present disclosure, the vendor 50 of the compute resource applications can continue to maintain control over both the activation and duration of use of its products.

The method 10 of the present disclosure further includes the step of submitting 16 the hardware Module ID 66 and user Registration ID 52 to an internet-based license database 70 for providing an activation license or install key 72. The internet-based license database can be located on internet server that is accessible from any remote location having access to the internet, and can operate in conjunction with the licensing architecture software 64 provided on each hardware module 60. Upon submission of the Module ID and Registration ID, the license database can combine the two identifications to provide an install key 72 that is unique to the identified module 60 so that only approved compute resource applications 54a . . . 54n installed on that particular hardware module can be enabled with the designated install key.

In one representative embodiment of the present disclosure, the Registration ID 52 can itself contain the information specifying the applications and durations of time that are authorized for use by the user (such as a compute resource ID number and a duration of time number). In another representative embodiment, however, the Registration ID can simply identify the user 40, and the information specifying the applications and durations of time can be uploaded 15 separately to the license database 70 by the compute resource software application vendor 50.

The method 10 of the present disclosure further includes the steps of accepting 18 the install key 72 from the internet license database 70 that comprises a module identification code 74 and software product selector code 76, and entering 20 the install key into the licensing architecture software 64 on the hardware module 60. It can be appreciated that accepting and entering the install key from the internet license database can occur simultaneously if the user is able to access the license database through the licensing architecture software installed onto the hardware module. It can also be appreciated that the steps of accepting and entering the install key can require separate and distinct computer programs to complete the two steps, such as one program to provide access to the internet, and another program to provide access to the hardware module either through a direct connection or over the network into which the hardware module has been installed.

As stated above, the install key 72 can include a module identification code 74 and a software product selector code 76. The method 10 of the present disclosure includes the step of using 22 the module identification code to enable the hardware module 60. More specifically, the licensing architecture software 64 installed onto the hardware module can use the module identification code 74 to verify that the downloaded install key applies to that particular hardware module by comparing the hardware module ID 66; otherwise, the install key can be held invalid and the licensing architecture software can prevent and compute resource software application from being enabled.

The method 10 of the present disclosure also includes the step of using 24 the software product selector code 76 to enable one or more compute resource applications 54a . . . 54n for the selected duration of time, thereby activating the network appliance 4. As stated above, each compute resource application can have its own compute resource application identification or Application ID. The Application ID can be recognizable or useable by the licensing architecture software in implementing the method and system of the present disclosure. In one representative embodiment, the Application ID can be based on the relative order of the compute resource application within a particular bundle of applications, so that an Application ID number of “005” refers to the 5th compute resource application in that application bundle. In another representative embodiment the Application ID can be based on an absolute referencing system, in which the Application ID number is unique among a complete library of compute resource applications, so that an application ID number of “276”, for example, can refer to a particular compute resource application without regard to any particular order or grouping with a bundle of applications. In another representative embodiment, an absolute Application ID can enable or disable certain features of the network appliance 4, for example, to allow any compute resource application to run on the module such as a Reseller may wish to utilize.

Each Application ID can be paired with a time duration identifier (“TDI”) that identifies the number of active days, the number of remaining days, etc., for which the associated compute resource application is to be enabled. In one representative embodiment, the time duration identifier can be a three digit numeral in which numbers 1-999 specify the number of remaining days, while the numeral 0 specifies activation for an indefinite (e.g. unlimited) duration of time. Another representative embodiment can include a shelf life to indicate the number of days an activation can be requested before the request is denied.

The software product selector code 76 can include an Application ID/TDI pair for each compute resource application 54a . . . 54n loaded onto the hardware module 60. In one representative embodiment, the software product selector code can further include a “Global” Application ID/TDI pair at a separate location in the software product selector code that can be applied to all compute resource applications loaded onto the hardware module. In one example, a Global Application ID with an unlimited TDI can function essentially as a master key, providing unlimited activation of all of the compute resource applications on the hardware module. In a more common scenario, the Global Application ID can be paired with a 365 day TDI, so that all of the compute resource applications loaded onto the hardware module can be enabled for a year.

The licensing architecture software 64 loaded onto each hardware module can implement and enforce the module identification code 74 and the software product selector code 76 included in the install key 72. For Global Application ID's and individual compute resource Application ID's paired with time duration indicators specifying a number of days, number of weeks, etc, the licensing architecture software can monitor the remaining time period available for each time period identifier, and then disable the selected application(s) when the selected duration of time expires to deactivate the network appliance 4 and enforce an end-of-license.

The licensing architecture software 64 can also be provided with a set of priority rules, so that differences between the individual application TDI's and the global application TDI's can be accounted for. For example, if the global application TDI is for one year, and an individual application's TDI is unlimited, the individual compute resource Application ID can be given a priority greater than the Global Application ID, so that the individual compute resource application can remain active after the time duration for the Global TDI expires.

The install key 72 can be installed independently of any compute resource software application or application bundle 54a . . . 54n loaded onto the hardware module 60, since the software product selector code portion 76 of install key can be based upon the separate agreement 42 between the customer 40 and the vendor 50 of the compute resource applications. Thus, it is possible for the install key to contain Application ID/TDI pairs that correspond to resource applications which have not yet been downloaded onto the hardware module, and which applications can be immediately enabled upon installation to become an active network appliance 4. In a similar fashion, if the customer has entered into an agreement for an install key containing a Global Application ID with a valid global TDI, such as 365 days, then any compute resource software application or application bundle loaded onto that particular hardware module will be enabled for the duration of the Global Application ID's authorized time duration.

The activation of the network appliance can be independent of the sequence between loading the compute resource software application or application bundle onto the hardware module and entering the install key into the licensing architecture software. The install key can be entered either before or after the loading of the compute resource applications without affecting activation, because the network appliance will only become active when both the correct compute resource application and correct install key are present on the same hardware module. Furthermore, once the install key has been entered into the licensing architecture software and used to activate the hardware module and the one or more compute resource applications, no further interaction (whether manual or automatic) between the licensing architecture software installed on the module and the internet licensing database may be required, as the stand-alone licensing architecture software can be configured to manage all the compute resource applications installed on that module for the duration of the license.

Because the software product selector code portion 76 of the install key 72 is associated with a particular user 40 and not irrevocably bound with the hardware module 60, in certain situations it can be desirable to remove the install key 72 from the hardware module in order to return the compute resource software application “rights” back to the customer who paid for them. This situation exists, for example, when an end-user decides to keep a reseller's network appliance at the end of a successful demonstration period. The reseller may want to retain his software product selector code 76 that broadly enables multiple applications, while the end-user may only want to purchase the activation rights for the single compute resource application which was successfully demonstrated on his network system. What is needed, therefore, is the capability to return the original install key 72 to the reseller and provide a new install key to the end-user without deactivating the network appliance 4.

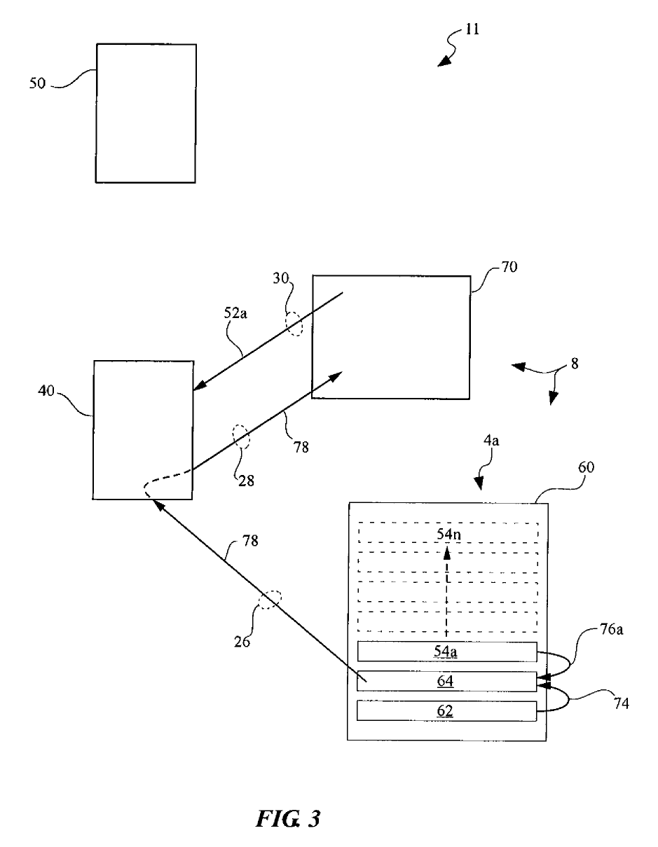

A representative method 11 of uninstalling the install key from the network appliance 4 forming a portion in the computer or network system 8 is further illustrated in FIG. 3, in accordance with one embodiment of the present disclosure. As shown, the licensing architecture software 64 installed onto the hardware module 60 can be directed to uninstall 26 the software product selector code 76a in the form of an Uninstall Verification ID 78. Like the install key, the Uninstall Verification ID can contain both the module identification code 74 and a software product selector code, but with a software product selector code 76a that has been modified to contain updated TDIs indicating the remaining days on the license, in order to reflect the up-to-date usage of the compute resource applications 54a . . . 54n with the original hardware module 60. The Uninstall Verification ID 78 can then be submitted 28 to the internet license database 70, which can return 30 an updated Registration ID 52a to the original customer 40 with the updated TDIs. Subsequently, the original user (e.g., the reseller) can then re-submit his updated Registration ID with a new Module ID from a new hardware module to the licensing database to receive a new install key for re-activating his network appliances on a new hardware module (not shown).

After uninstalling 26 the Uninstall Verification ID 78 returning an updated registration ID 52a to the original user 40 through the internet licensing database 70, the licensing architecture software 64 on the original module 60 can continue to allow uninterrupted operation of the selected network appliance 4a for a predetermined time window before enforcing an end-of-license. This time window, typically one to five business days in duration, can give the new customer (e.g. the end-user) time to purchase their own Registration ID from the compute resource appliance vendor 50, and then to submit the new Registration ID along with the original hardware Module ID to the internet license database to receive a new install key enabling the selected compute resource software application 54a.

The above detailed description describes the disclosure with reference to specific representative embodiments. However, it will be appreciated that various modifications and changes can be made without departing from the scope of the present disclosure as set forth in the appended claims. The detailed description and accompanying drawings are to be regarded as merely illustrative, rather than as restrictive, and all such modifications or changes, if any, are intended to fall within the scope of the present disclosure as described and set forth herein. More specifically, while illustrative representative embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. Also, any steps recited in any method or process claims can be executed in any order and are not limited to the order presented in the claims.

What is claimed is:

1. A method of activating a network appliance, comprising:
obtaining a computer hardware module having an open architecture operating system and licensing architecture software, and having a hardware module identification;
receiving a user registration identification preconfigured in accordance with a user's selection of at least one compute resource application for a selected duration of time;
submitting the hardware module identification and user registration identification to an internet-based license database server for providing an install key;
accepting the install key from the license database server comprising a module identification code and software product selector code;
entering the install key into the licensing architecture software on the hardware module;
using the module identification code to enable the hardware module; and
using the software product selector code to enable the at least one compute resource application for the selected duration of time, thereby activating the network appliance.

2. The method of claim 1, further comprising downloading the at least one compute resource application onto the hardware module.

3. The method of claim 1, further comprising disabling the at least one compute resource application when the selected duration of time expires to deactivate the network appliance and enforce an end-of-license.

4. The method of claim 1, further comprising downloading a second at least one compute resource application onto the hardware module to overwrite the first at least one licensed compute resource application, wherein the software product selector code enables the second at least one compute resource application for the selected duration of time, thereby activating a second network appliance.

5. The method of claim 1, further comprising:
uninstalling the install key from the network module to receive an uninstall verification identification from the licensing architecture software;
submitting the uninstall verification identification to the internet-based license database for providing an updated user registration identification; and
allowing uninterrupted activation of the network appliance for a predetermined time window before enforcing an end-of-license, to allow the time window for entering a new install key.

6. The method of claim 1, wherein the at least one compute resource application further comprises a predetermined bundle of individual compute resource applications.

7. The method of claim 6, wherein the user's selection further comprises selecting from the group consisting of the individual compute resource applications and the bundle of individual compute resource applications.

8. The method of claim 6, wherein the user's selection further comprises selecting from the group consisting of a number of remaining days and unlimited duration.

9. The method of claim 6, wherein a reseller's selection further comprises selecting all of the predetermined bundle of individual compute resource applications for a one year duration.

10. The method of claim 1, wherein a purchasing user's selection further comprises selecting the at least one of the compute resource application for an unlimited duration.

11. The method of claim 1, wherein the hardware module is a server blade installed into a network switch chassis.

12. The method of claim 1, wherein the predetermined bundle of individual compute resource applications further comprises a plurality of licensed compute resource applications configured to run on a network server switch having an HP licensing architecture software running on an HP Open Network Ecosystem™ operating system.

13. The method of claim 12, wherein the network appliance is selected from the group consisting of a load balancing appliance, a firewall appliance, a voice-over-IP telephone switch appliance, a wireless network appliance, a data processing appliance, a data storage appliance, an optical communications interconnect appliance, and a diagnostic tool appliance.

14. A system for activating a network appliance, comprising:
a computer hardware module having an open architecture operating system and licensing architecture software, and having a hardware module identification;
at least one compute resource application downloaded onto the hardware module;
a user registration identification preconfigured in accordance with a user's selection of one of the at least one compute resource application for a selected duration of time; and
an internet-based license database server,
wherein the license database server responds to a submission of the hardware module identification and user registration identification with an install key comprising a module identification code for enabling the hardware module and a software product selector code for enabling the selected one of the at least one compute resource application for the selected duration of time, thereby remotely activating the network appliance.

15. The method of claim 14, wherein the at least one compute resource application further comprises a predetermined bundle of individual compute resource applications.

16. The method of claim 15, wherein the user's selection further comprises selecting from the group consisting of the individual compute resource applications and the bundle of individual compute resource applications.

17. The method of claim 15, wherein the user's selection further comprises selecting from the group consisting of a number of remaining days and unlimited duration.

18. The method of claim 15, wherein a reseller's selection further comprises selecting all of the predetermined bundle of individual compute resource applications for a predetermined duration.

19. The method of claim 14, wherein a purchasing user's selection further comprises selecting the at least one of the compute resource application for an unlimited duration.
